(19) United States
(12) Patent Application Publication
(10) Pub. No.: US 2015/0322916 A1
(43) Pub. Date: Nov. 12, 2015

(54) SOILING SHIELD FOR WIND TURBINE BLADE

(71) Applicant: Siemens Aktiengesellschaft, München (DE)

(72) Inventor: Alonso O. Zamora Rodriguez, Boulder, CO (US)

(73) Assignee: Siemens Aktiengesellschaft, München (DE)

(21) Appl. No.: 14/272,536

(22) Filed: May 8, 2014

(51) Int. Cl. F03D 1/06; F03D 1/00; F03D 11/00

(52) U.S. Cl. CPC F03D 1/0641; F03D 11/00; F03D 1/001

(57) ABSTRACT

A soiling shield (80) affixed to a blade airfoil (22) of a wind turbine generator (20). The soiling shield (80) includes a portion extending along and spaced apart from a pressure side surface (88) of the blade airfoil (22). The soiling shield (80) is positioned not to impede an air flow stream (98) flowing to a stagnation point (130) on the pressure side surface (88) during operation of the wind turbine generator (20) at or below rated power.

### FIELD OF THE INVENTION

This invention relates generally to the field of wind turbine generators, and more specifically to an apparatus for reducing the accretion of foreign objects on a wind turbine blade.

### BACKGROUND OF THE INVENTION

As is known in the art, wind kinetic energy is converted to electrical energy with a wind turbine generator (WTG). The wind turbine generator comprises rotor blades for converting wind energy to rotational energy for driving a shaft connected to a gearbox. The gearbox converts low speed rotation to high speed rotation as required for driving a generator that generates electricity. Certain WTGs lack the gearbox and instead the generator is driven directly from the shaft. The wind turbine generator also includes various control components (for example to change a blade pitch), a structural support, such as a tower, and a rotor yawing system for orienting the rotor plane perpendicular to the oncoming wind.

The WTG converts wind energy to rotational energy by efficiently slowing down incoming wind, reducing its kinetic energy and transferring that kinetic to rotational energy to rotate a generator for generating electricity. The efficiency of this process depends on the blade area within a rotor plane and on the aerodynamic performance of the blades. Rotor blade design considers power generated, noise emissions, structural integrity and loading limits.

Axial induction is a measure of the amount by which the incoming wind is slowed down, i.e., a ratio of the wind speed after impinging the rotor blades to the incoming wind speed.

An airfoil is a cross-sectional slice of a lift-producing body, such as a WTG blade. An airfoil angle of attack is the angle between an airfoil chord and a vector parallel to the incoming air flow. Blade performance is represented by force fields in the flow stream. Lift and drag vector components (both functions of the angle of attack) are vectorially added to produce an aerodynamic force vector.

Lift of an airfoil is primarily generated from a pressure difference between an upper and lower side of an airfoil. Airfoils are designed to accelerate flow around a leading edge of the airfoil thereby lowering pressure at that edge. WTG blade airfoils are designed to produce more acceleration over an upper or suction side of the airfoil blade than over a lower or pressure side during normal operation at any power level below the WTG rated power. At very high wind speeds (e.g., greater than about 25 m/second) the blades are pitched to a low angle of attack that in certain areas of the blade may result in greater acceleration over the pressure airfoil side.

Wind turbine blade soiling is specifically a leading edge surface contamination problem characterized by impingement of foreign objects on the leading edge during blade rotation. These foreign objects, e.g., dust, mud, dead insects, salt and other airborne objects, then accumulate on the blade surfaces.

Severe soiling environments are characterized by large flying insect populations, low humidity, intermittent rain and farming activities that loosen top soil.

The severity of the soiling also depends on geographical location, weather patterns, and seasonal variations. In the United States, blade soiling is an acute problem in particular in the Midwest.

This accretion of foreign objects on or near the leading edge of a wind turbine blade degrades blade performance, reduces annual energy production from the WTG and increases noise emitted by the WTG. Soiling may also lead to permanent roughing of the blade leading edge.

Specifically, soiling disturbs a flow boundary layer along the blade thereby increasing kinetic energy losses in a near-wall air flow stream. Decreasing kinetic energy directly decreases the rotational blade energy, and since the WTG generates electricity by converting kinetic energy to rotational energy, the amount of electricity generated also decreases.

Soiling can also create a fully turbulent air flow over the entire blade airfoil. This phenomenon reduces aerodynamic efficiency throughout the blade, negatively influencing both power production and noise emissions.

Blade soiling can also generate more warranty claims due to the decreased output power of the WTG. Other effects of soiling include additional costs associated with removal of the accreted material, engineering hours devoted to on-site trouble shooting, and engineering hours devoted to mitigating blade soiling.

When blade soiling increases noise emissions, serrated or chevrous-shaped strips, also known as DinoTails, can be affixed to the trailing edge of a WTG blade to reduce the noise emissions.

Knowledge of airfoil dynamics under soiled blade conditions must be considered when designing blades. Blades can be designed with an aerodynamic efficiency that not only maximizes annual energy power output under clean blade conditions, but also lowers sensitivity to blade soiling. To reduce the sensitivity to blade soiling, certain compromises can be made during deign of the WTG blades. These decisions may result in sacrificing some “clean blade surface” energy production, resulting in turbines with reduced annual energy production and reduced capacity factors.

Periodic blade cleaning is a straightforward solution to the blade soiling problem and one that can be easily implemented by the WTG owner. But it is difficult to determine a level of blade soiling that justifies blade cleaning. Also, cleaning the blades is a time consuming and expensive operation, requiring the use of special equipment (e.g., cranes) and of course shutting down the WTG.

In one prior art technique for reducing soiling, vortex generators are installed (as an add-on solution after commissioning of the WTG) on outboard sections of the wind turbine blades. The outboard section is generally defined as that segment of the blade between a mid-span chord and the blade tip.

Vortex generators with right scalene triangle shapes are typically installed in same-size pairs along an outboard surface of a blade. Several differently shaped vortex generators are installed along the blade length. The vortex generators create an air vortex that travels downstream along the blade surface, i.e., from the leading edge to the trailing edge or along the blade airfoil chord, entraining kinetic energy from the free-stream flow into a near-wall flow. Each vortex generator pair generates counter-rotating vortices that operate effectively to reduce blade soiling. The additional energy transferred to the near-wall flow also aids in reducing the negative effects of soiling by delaying flow separation along the blade airfoil. Flow separation has a negative effect on WTG efficiency. The familiar airfoil stall phenomenon is an example of air flow separation.

### BRIEF DESCRIPTION OF THE DRAWINGS

The invention is explained in the following description in view of the drawings that show:

FIG. 1 is a suction side view of a prior art wind turbine generator.

FIG. 2 is an orthogonal view of an inboard portion of a prior art wind turbine blade.

FIG. 3 is a graph of a lift coefficient as a function of angle of attack and depicts the effects of blade soiling.

FIG. 4 is a graph of a drag coefficient as a function of angle of attack and depicts the effects of blade soiling.

FIG. 5 is a transverse cross-sectional view of an airfoil with a soiling shield of the present invention further depicting air flow vectors and blade soiling elements.

FIGS. 6-9 are transverse cross-sectional views of an airfoil with a soiling shield installed at various locations relative to the airfoil.

FIG. 10 is a transverse cross-sectional view of a soiling shield installed on an unconventionally shaped airfoil.

FIG. 11 is a transverse cross-sectional view of an airfoil and a soiling shield depicting an angle of attack of the airfoil.

FIGS. 12 and 13 illustrate components for attaching the shield to the blade airfoil.

FIG. 14 illustrates vortex generators for use with the soiling shield of the present invention.

FIG. 15 illustrates a block diagram of components for controlling a moveable shield.

FIGS. 16 and 17 identify distances defined between certain points on the shield and points on the blade.

FIG. 18 illustrates certain geometric features for defining an angle between the soiling shield and the blade airfoil.

FIG. 19 illustrates a soiling shield comprising two separate portions.

### DETAILED DESCRIPTION OF THE INVENTION

Given the problems associated with wind turbine blade soiling as described above, there is a need to reduce blade soiling to improve wind turbine generator performance.

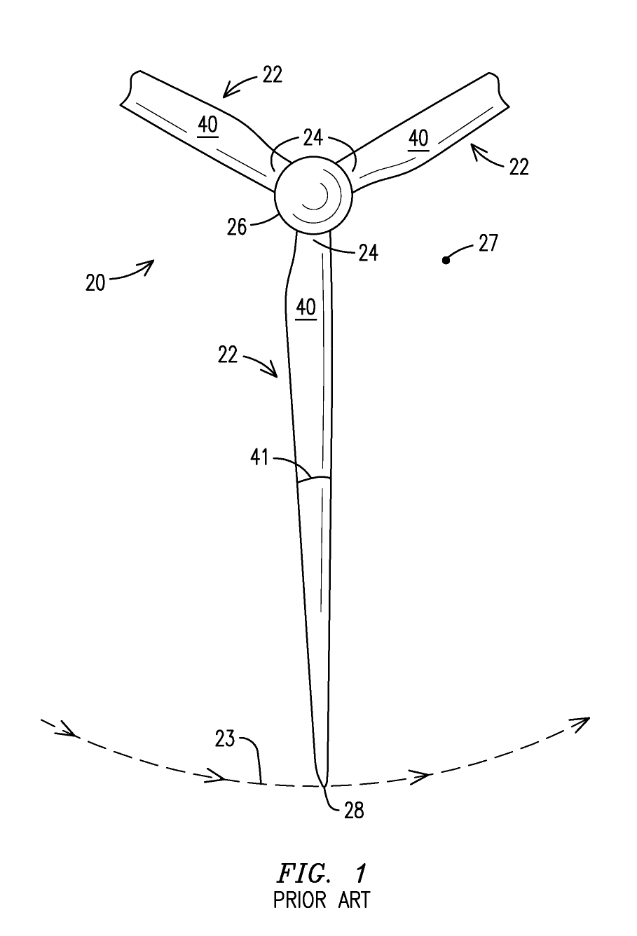

FIG. 1 illustrates a suction side (or back side) of a prior art wind turbine generator (WTG) 20 with radially-oriented blade airfoils 22, also referred to as main airfoils or simply airfoils, that rotate generally in a counter clockwise direction 23 when viewed from the suction side. A vector tip 27 represents incoming wind, i.e., the wind flowing out of the sheet. A circle circumscribed by the rotating blades is referred to as a disc of rotation or a rotor plane. Suction sides 40 of the blade airfoils 22 are seen in this FIG. 1 view. Only rotating elements are illustrated in FIG. 1; for example, the nacelle and WTG tower are not shown.

Each blade airfoil 22 extends radially from an inboard end or root end 24 to a tip end 28. The root end 24, attached to a hub 26, is relatively thick to withstand flapwise loads imposed normal to a chord of the blade airfoil. Generally, the inboard blade section is defined as a segment of the blade between the root end 24 and a mid-span chord 41, and the outboard section is defined as a segment between the mid-span chord 41 and the tip end 28.

FIG. 2 is an orthogonal view of an inboard section 36 of the blade airfoil 22 defining a pressure side 38 and the suction side 40. The blade 22 further comprises a leading edge 42, which is the most-forward point of the blade airfoil relative to a trailing edge 44. The leading edge 42 is a geometric feature of the blade 22 independent of the blade angle of attack.

Transverse cross-sectional profiles of the blade gradually transition from a circular shape at the root end 24 to an airfoil shape at and beyond (i.e., radially outwardly) of a shoulder region 47. Generally the shoulder region 47 is defined as proximate the chord having the longest blade chord length.

Continuing with reference to FIG. 2, a blade airfoil chord 96 is defined as a geometric blade feature between a trailing edge point 50 and a leading edge point 54.

As the transverse cross-sectional profiles of the chord change along the blade's length between the hub end 24 and the tip end 28 a chord length changes. Also, the chord 96 is considered the line of demarcation between a pressure side 38 and a suction side 40 of the blade airfoil.

Typically, the blade airfoil dimensions are given as a percent of a local chord length, where the local chord length is defined as the chord in the immediate vicinity of interest. For example, 0% of chord length is defined as a leading edge point of the blade airfoil, e.g., at the leading edge point 54 in FIG. 2. 100% of the chord length is defined as the trailing edge point of the blade airfoil, e.g., at the trailing edge point 50 in FIG. 2.

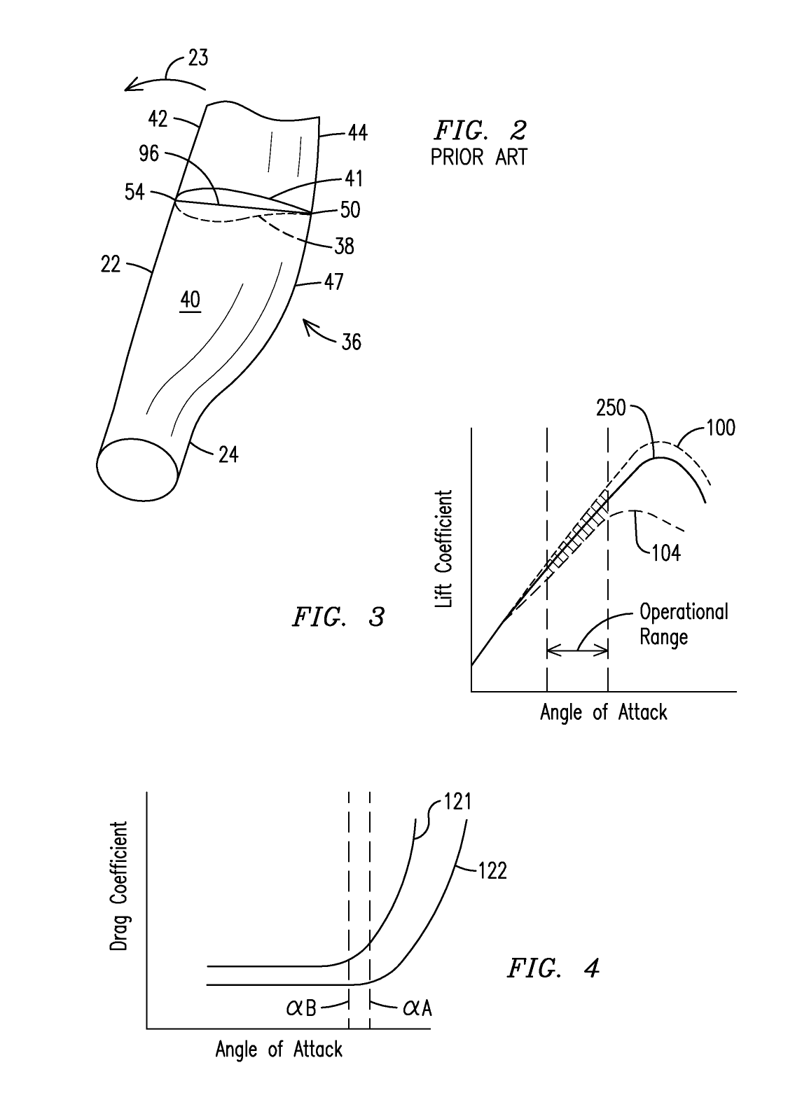

FIG. 3 is a graph of a lift coefficient on the Y-axis as a function of an angle of attack on the X-axis. The curves of FIG. 3 show a reduction in the lift coefficient (that causes a corresponding degradation in WTG performance) from a clean blade surface represented by a curve 100 to a soiled blade surface represented by a curve 104. The conventional operational range of angles of attack is also depicted.

The loss of lift (i.e., a lower lift coefficient) due to blade soiling lowers the local axial induction factor with a consequent drop in WTG output power. Blade soiling causes earlier separation of the airflow from the surface of the blade due to the loss of momentum or kinetic energy in the airflow.

FIG. 4 depicts a drag coefficient as a function of the angle of attack α. A curve 121 depicts the drag coefficient for a soiled blade and a curve 122 indicates the drag coefficient for a non-soiled blade. Flow separation begins where the curve 121 or 122 turns upwardly, i.e., at an angle of attack α_{B} for the soiled blade and at an angle of attack α_{A} for the non-soiled blade. Note that α_{B}<α_{A}.

When flow separation occurs (i.e., separation of the airflow from the blade airfoil) the drag coefficient increases rapidly. Noise emissions also increase when the drag coefficient increases. Thus FIG. 4 graphically illustrates that blade soiling causes flow separation at a lower angle of attack than for a non-soiled blade, thereby increasing the drag coefficient and increasing noise emissions at a lower angle of attack.

As shown in FIG. 5, the present invention teaches a shield 80 disposed in front of the leading edge 42 of the blade airfoil 22 to capture dirt, insects 84, etc. and thereby shield the leading edge 42 from these blade-spoiling elements. As is known by those skilled in the art, strong favorable pressure gradients develop along the leading edge 42, making this edge especially susceptible to WTG performance degradation due to the surface roughness caused by such blade spoiling.

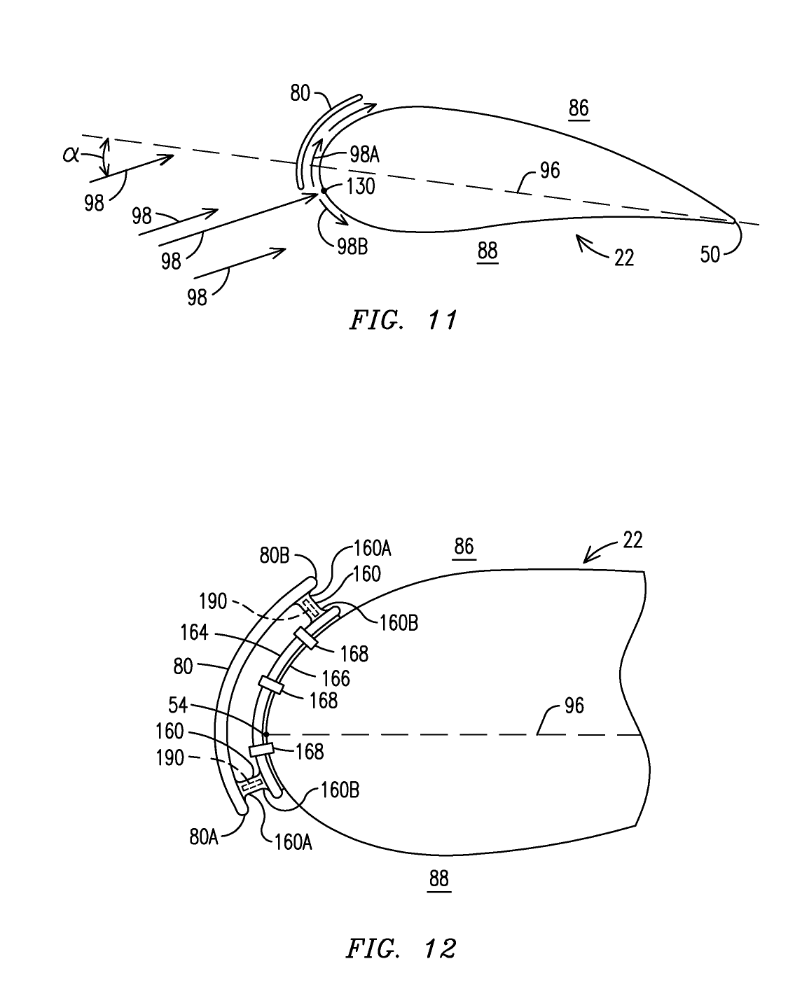

Although not specifically shown in FIG. 5, in one embodiment the shield 80 is fixedly or immovably attached to the blade airfoil 22 or to an intervening component that is in turn fixedly or immovably attached to the blade airfoil 22. Components for use in attaching the shield to the blade airfoil are described in detail below in conjunction with FIGS. 12 and 13.

The shield 80 is generally not considered an aerodynamic component of the blade airfoil 22 or of the WTG. As known by those skilled in the art, an aerodynamic component is one that affects the motion of air streams and influences the motion of bodies in the air streams, i.e., a body creating lift or drag forces. But in fact, every body, whether or not characterized as an aerodynamic body, can create lift and drag. An aerodynamic body then is defined as one that has been designed to create lift and drag, e.g., one that is more slender than, for example, a circle or an ellipse in cross-section.

Because the shield of the present invention is not designed or shaped to produce meaningful lift, it is generally not considered an aerodynamic body as described above. The shield is aligned with the local air flow around the shape of the blade and does not create any meaningful adverse or beneficial effects from an aerodynamic point of view, i.e., it does not create any meaningful lift or drag forces during normal operation of the WTG. Normal operation of the WTG is considered operation at or below rated power production at angles of attack between about 0° and 10°. The shield 80 does not create more than about 10% of a total lift component when the WTG is operating within its normal operating range, i.e., when the blade angle of attack is between about 0° and 10°.

Also the shield 80 does not disturb the airflow (e.g., induce any flow separation points) at any operational angles of attack, i.e., angles of attack between about 0° and 10° when the WTG is producing power at or below the rated power of the WTG.

Continuing with FIG. 5, a suction side 86 and a pressure side 88 of the blade airfoil 22 are also illustrated. Shield end points 80A and 80B are also shown. The chord 96 is depicted in the transverse airfoil cross-section of FIG. 5. The leading edge point 54 and the trailing edge point 50 are also shown.

The angle of attack α is also illustrated. The angle of attack (also referred to as the blade airfoil pitch) is the angle between the chord 96 and a direction of the incoming airflow, which direction is indicated by air flow vectors 98.

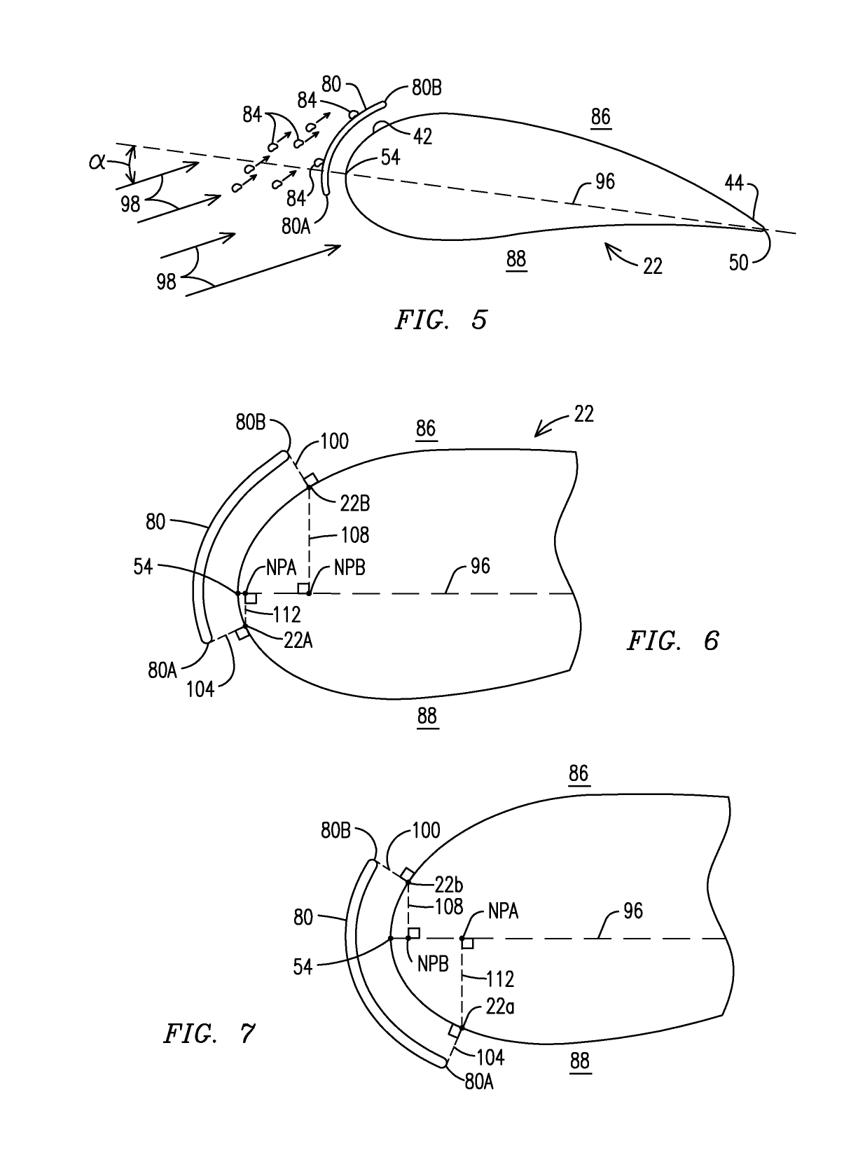

FIGS. 6-10 illustrate various embodiments regarding placement of the shield 80 relative to the leading edge, without regard to a direction of the incoming air flow.

In FIG. 6 a portion of the shield 80 extends along the suction side 86 and a shorter portion along the pressure side 88.

FIG. 6 also illustrates a line 100 that extends from the point 80B to a perpendicular intersection with a surface of the blade airfoil 22. That intersection point is designated by a reference numeral 22B. From the point 22B a line 108 extends to a perpendicular intersection with the chord 96 at a point NPB.

Similarly, a line 104 extends from the point 80A to a perpendicular intersection with a surface of the blade airfoil 22 at a point 22A. From the point 22A a line 112 extends to a perpendicular intersection with the chord 96 at a point NPA.

D_{A} is defined as a distance between the points 54 and NPA along the chord 96. D_{B} is defined as a distance between the points 54 and NPB along the chord 96. Both D_{A} and D_{B} are between about 0% and 10% of the length of the chord 96. In FIG. 6 the distance D_{A} is shorter than the distance D_{B}.

Given that the distances D_{A} and D_{B} are both generally expressed in ranges, in different embodiments the shield 80 may extend over different segments of the leading edge of the blade airfoil 22, such as the embodiments illustrated in FIGS. 6-10. In the embodiments of FIGS. 6-8 the distances D_{A} and D_{B} are not equal thus the shield 80 is not centered about the point 54. In FIGS. 9 and 10 D_{A}=D_{B} and the shield 80 is centered about the leading edge point 54.

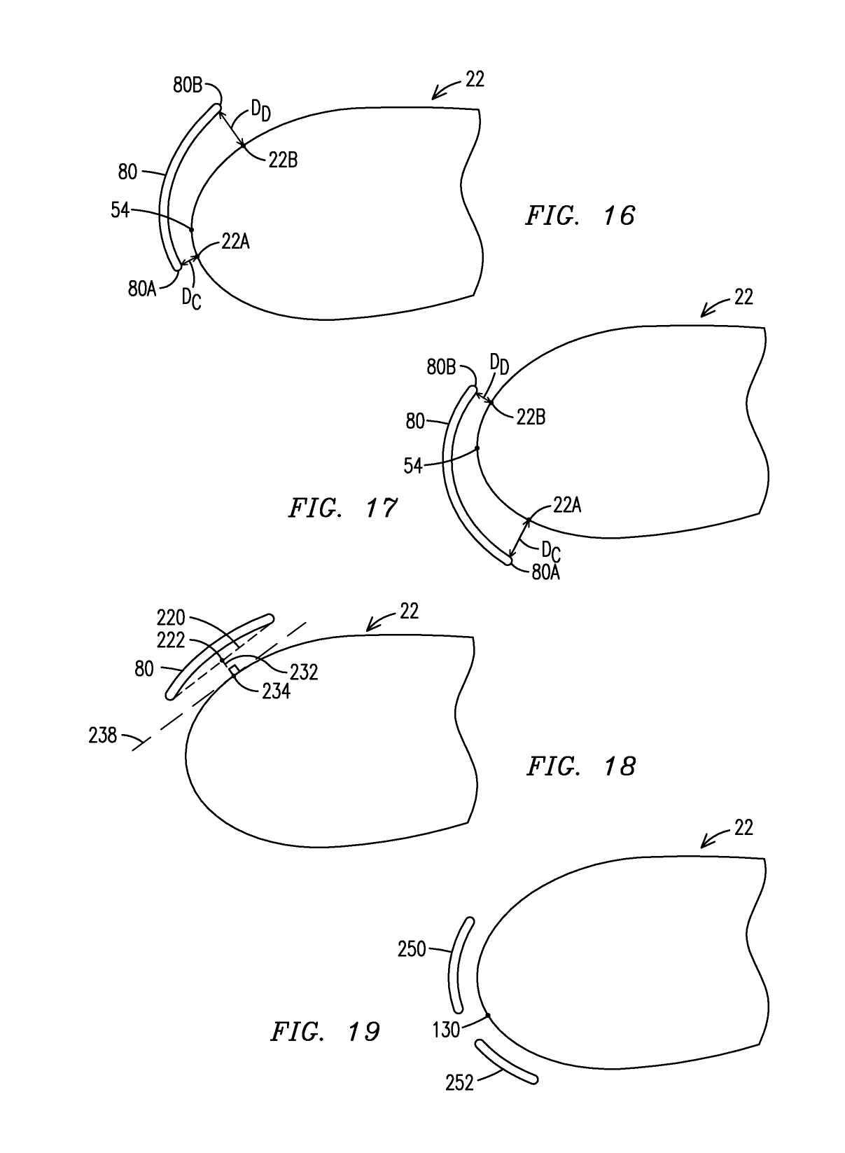

FIGS. 16 and 17 depict additional distances associated with the shield 80 and its placement relative to the blade airfoil 22. A distance D_{C} is defined as the distance between the shield end point 80A and the point 22A on the surface of the blade 22. A distance D_{D} is defined as the distance between the shield end point 80B and the point 22B on the surface of the blade 22.

In the FIGS. 6-10 the shield 80 is oriented such that D_{C}=D_{D} and the shield is not tilted relative to the blade airfoil 22 or the point 54.

In an embodiment of FIG. 16 the orientation of the shield 80 is tilted relative to the blade surface such that these two distances are not equal. In FIG. 16 the distance D_{C} is less than the distance D_{D}.

In an embodiment of FIG. 17 the distance D_{C} is greater than the distance D_{D} and the shield is tilted in the opposite direction from its orientation in FIG. 16.

Preferably, each distance D_{C} and D_{D} is between about 2 and 20 cm. At a distance less than about 2 cm. the shield 80 has an adverse effect on the airflow streams and the aerodynamic properties of the blade airfoil 22. At a distance greater than about 20 cm. the shield will not be effective to stop insects, debris, etc. from reaching the surface of the blade airfoil 22. Preferably, the distances D_{C} and D_{D} should be within about ±5 cm of each other.

The ranges associated with the distances D_{A}, D_{B}, D_{C}, and D_{D} offer several degrees of freedom in positioning and orienting the shield to accommodate different blade airfoil designs, leading edge shapes and prevalent wind directions at the WTG site.

In FIG. 7 the shield 80 is disposed with a longer portion along the pressure side 88 and a shorter portion along the suction side 86. The distance D_{A} is longer than the distance D_{B}.

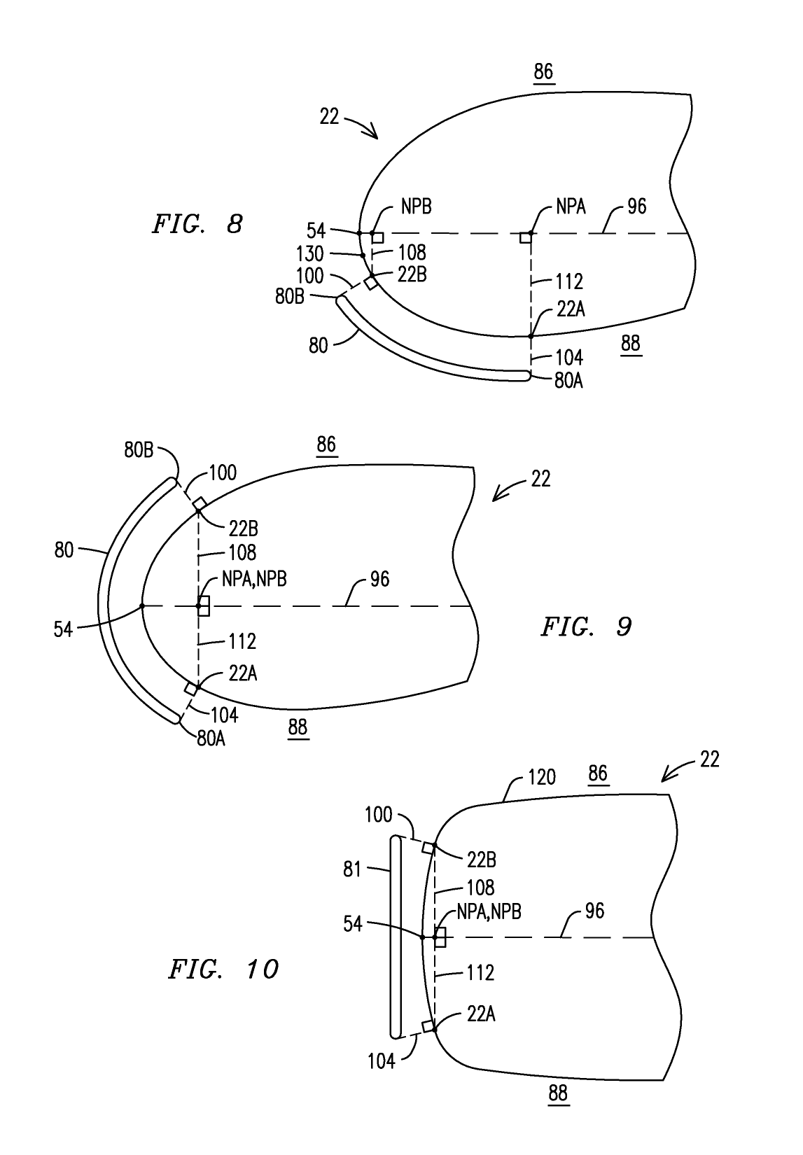

In FIG. 8 the shield 80 is disposed with the entire length of the shield along the pressure side 88. Again, the distance D_{A} is greater than the distance D_{B}.

In yet another embodiment of FIG. 9, the points NPA and NPB are coincident and therefore the distance D_{A} equals the distance D_{B}. The shield 80 is accordingly symmetric about the leading edge point 54.

FIG. 10 depicts an unconventionally shaped blade 120 with a planar shield 81 symmetrical about the leading edge point 54. The points NPA and NPB are coincident and therefore the distance D_{A} equals the distance D_{B}. In lieu of the planar shield 81, a curved shield, such as the soiling shield 80 illustrated in the various embodiments, can be used in conjunction with the blade 120.

In FIG. 11 airflow is indicated by incoming air flow vectors 98. The air flow is in fact a continuum of air flow vectors but only representative vectors are illustrated. The incoming air flow strikes the blade airfoil 22 and the airflow stagnates (i.e., its velocity goes to zero) at a stagnation point 130. The air stream splits at the stagnation point 130 into streams 98A and 98B. Air flow streams that do not strike the stagnation point 130 merge into airflow streams 98A or 98B.

Preferably the air flow stagnates on the blade 22 and the air flow is not significantly disturbed by the presence of the shield 80. Since the most forward point of the blade airfoil changes with the angle of attack, the blade and shield are designed and located relative to each other such that for the most common operating conditions (based on the most common wind direction and velocity at the site of the WTG and a site-specific most common angle of attack at or below the rated output power) the stagnation point on the blade airfoil is not blocked by the shield 80.

In FIG. 11 the blade airfoil 22 is depicted at a positive angle of attack. At negative angles of attack the shield may trigger earlier flow separation, i.e., before the air flow reaches the airfoil. This earlier airflow separation is not desired during normal operation of the WTG. But earlier flow separation can be tolerated if the flow separation does not occur at an angle of attack that is used during normal operation, i.e., the flow separation occurs at angles of attack less than about −5 degrees.

As the blades are pitched responsive to changes in wind direction the stagnation point moves. During WTG operation below rated power, the WTG controller and actuators change both the pitch and the RPMs of the rotor in response to changes in air flow direction and speed to maintain the same angle of attack (and therefore the same stagnation point).

However above rated power, the rotational speed of the rotor is not typically changed, but the pitch is changed as the wind speed increases in such a way that the angle of attack changes and becomes negative. The blades are pitched under these conditions to reduce wind loads on the blades. Of course in this scenario the stagnation point definitely moves as the blades are pitched away from their normal angle of attack (i.e., where the normal angle of attack is considered that angle of attack when the WTG is operating at or below its rated power).

In one embodiment the soiling shield 80 has a constant thickness along its radial length between the blade tip and the blade root. For example, the shield thickness is about 5 mm.

According to another embodiment the thickness of the soiling shield 80 varies along its radial length. The thickness varies between about 5% and about 12% of the blade's local chord length at any transverse cross-section.

As used herein the reference to constant thickness excludes the shield endpoints 80A and 80B, which may be rounded, pointed, serrated or chevrous (e.g., with flexible vortex generators attached) for aerodynamic efficiency.

In one embodiment a shape of the shield is concave (from the perspective of the blade airfoil) as illustrated in the various figures. The shield may also be planar as illustrated in FIG. 10.

In yet another embodiment the shape of the shield 80 follows the contour of the leading edge of the blade airfoil 22. According to this embodiment the shield is shaped and located so that its contour is aligned with the airflow streams, i.e., the contour follows the curvature of the airflow streams, where the curvature of the airflow streams follows the contour of the leading edge of the blade airfoil. With this shape, the shield 80 does not substantially interact with the airflow streams during normal WTG operation. It is not an aerodynamic component and therefore does not provide any meaningful additional lift or drag during normal operation of the WTG.

FIG. 18 illustrates the concept of the shield contour following the airflow streams. The shield 80 defines a shield chord 220 having a shield chord midpoint 222. A line 232 is projected from the chord midpoint 222 to perpendicularly intersect the blade airfoil 22 at a point 234. A line 238 is tangent to the blade airfoil at the point 234. The shield is regarded as being aligned with the airflow when the angle between the shield chord 220 and the line 238 is between about +30° and −30°.

A length of the soiling shield along the shield surface between the endpoints 80A and 80B is between about 1% and about 20% of the local chord length.

The soiling shield 80 can be made from any material that does not attract lightning. For example, the shield 80 can be formed from the same material(s), e.g., a plastic or a fiber material as other blade add-on components (e.g., vortex generators as described elsewhere herein).

In one embodiment the shield 80 may be constructed of a deformable material that deforms in situ to a profile of the airflow streams that flow over the blade airfoil. Such a shield minimizes disruption of the airflow streams after it has assumed a shape of those airflow streams.

Components for attaching the shield 80 to the blade airfoil 22 are dependent on the lift and drag forces exerted on the shield.

A lightly loaded shield is preferred, i.e., where the shield is designed and configured with respect to the blade 22 to carry only light loads and not intended to withstand significant lift and drag loads.

With reference to FIG. 12, a first end 160A of struts 160 is attached to the shield 80 using an adhesive or fasteners. A second end 160B of each strut 160 is secured to a plate 164 that is in turn attached to the blade airfoil 22 by an adhesive material 166 or fasteners 168. Generally, in applications where the shield will be lightly loaded use of the adhesive material is preferred to reduce the weight of the blade airfoil.

In certain embodiments the plate 164, the adhesive material 166 and the fasteners 168 are not utilized and instead the end 160B is directly attached to the blade airfoil 22, again using fasteners or an adhesive material.

Generally, the blade airfoil comprises a skin surface and radially-extending internal spars with transverse ribs connected to the spars. As illustrated in FIG. 13, for heavily loaded shields struts 179 penetrate a blade skin 180 and are attached to an airfoil spar 182.

The struts 160 and 179 are spaced radially along a length of the blade with a distance between spars dependent on the loads exerted on the airfoil. For example the struts may be placed at about 2 meter intervals.

In one embodiment the struts 160 and 179 comprise a core of visco-elastic material 190 (see FIGS. 12 and 13) to dampen loads and thereby limit loads transferred from the shield to the blade.

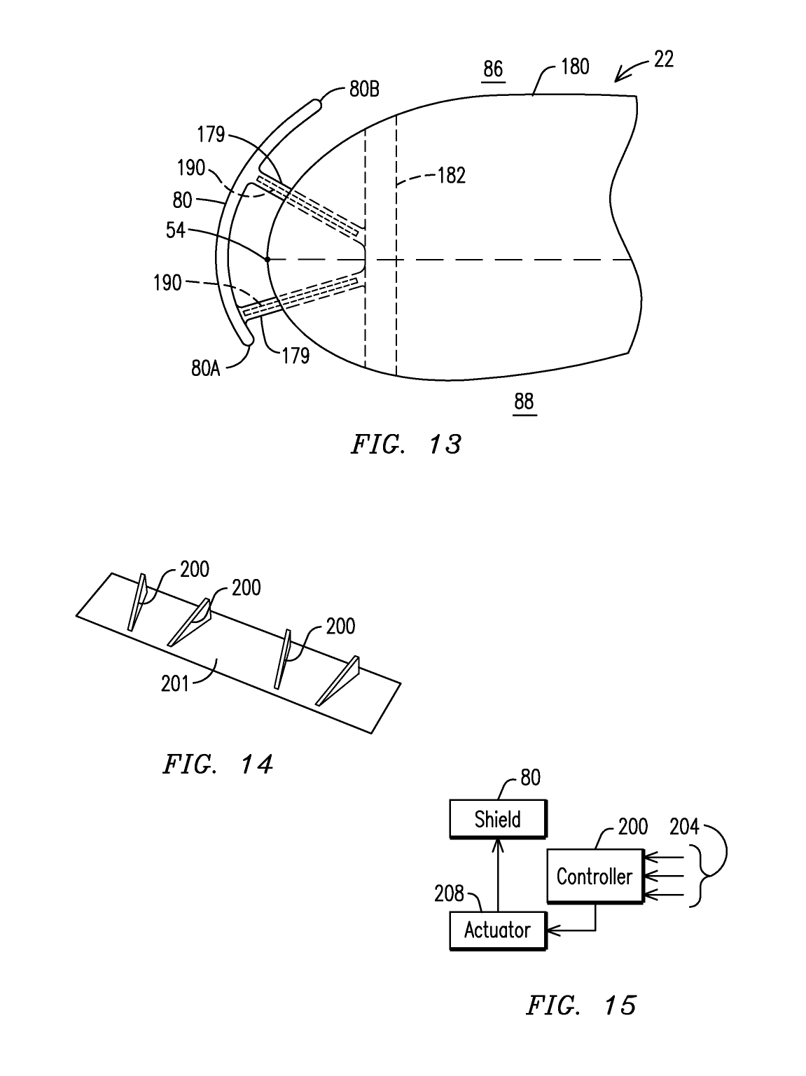

Vortex generators 200 affixed to a base 201, as illustrated in FIG. 14, may be attached to the plate 164 of FIG. 12. These vortex generators can re-energize the air flow after the air flow stream has lost energy due to blade soiling.

The shield can extend radially from blade tip to blade root, or along any segment of the blade. In one embodiment the shield is positioned only along the outboard segment of the blade.

Since in one embodiment the shield 80 is affixed to the blade airfoil 22, the shield is also pitched with the blade, i.e., the orientation of the shield remains fixed relative to the orientation of the blade.

But in another embodiment the shield is moveable relative to the blade. The shield 80 may be pivotable about the struts 160/179 for positioning the shield as wind inflow conditions change. The position of the shield relative to the blade can be manually controlled or controlled remotely by the WTG control system.

FIG. 15 illustrates a block diagram of a controller for controlling a position and orientation of the soiling shield. A controller 200 receives input signals 204 representing airflow direction, air flow velocity, blade revolutions per minute, etc. In response to the input signals 204, the controller 200 controls shield actuators 208 that control a position and/or an orientation of the soiling shield, such as by lengthening or shortening one or both of the struts 160 in FIG. 12.

In one embodiment a moveable shield serves a dual purpose of preventing debris and insects from spoiling the blade and of disrupting the airflow as a spoiler/slat. In this latter embodiment a gap between the soiling shield and the blade airfoil is regulated to control the airflow disruption.

FIG. 19 illustrates an embodiment wherein the soiling shield comprises a first soiling shield portion 250 and a second soiling shield portion 252, the first and second portions separated by the stagnation point 130.

Returning to FIG. 3 a curve 250 shows the beneficial effects on the lift coefficient for various angles of attack when the shield 80 is in place. Clearly the curve 250 increases the lift coefficient relative to the curve 104 (for a spoiled blade). The lift coefficient for a clean blade surface is represented by the curve 100.

As used herein, the terms axial and radial with reference to the blade airfoil and the soiling shield are used interchangeably to refer to a direction from a blade tip to a blade root or vice versa.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A wind turbine generator comprising:
a blade airfoil; and
a soiling shield comprising a portion extending along and spaced apart from a pressure side surface of the blade airfoil; and
wherein the soiling shield is positioned not to impede an air flow stream flowing to a stagnation point on the pressure side surface during operation of the wind turbine generator at or below rated power.

2. The wind turbine generator of claim 1, wherein the soiling shield further comprises a portion extending along and spaced apart from a suction side surface of the blade airfoil.

3. The wind turbine generator of claim 1 the soiling shield extending radially along at least a segment of the blade airfoil.

4. The wind turbine generator of claim 1 wherein a cross-sectional thickness of the soiling shield is generally constant along a radial length of the soiling shield.

5. The wind turbine generator of claim 1 wherein a cross-sectional thickness of the soiling shield along a radial length of the soiling shield is less than 12% of a local blade chord length.

6. The wind turbine generator of claim 1 wherein a cross-sectional thickness of the soiling shield is 5 mm.

7. The wind turbine generator of claim 1 wherein a cross-sectional shape of the soiling shield is planar, concave or follows a contour of a blade airfoil leading edge.

8. The wind turbine generator of claim 1 wherein during rated power operation of the wind turbine generator, an angle of attack of the blade airfoil is between 0° and 10°.

9. The wind turbine generator of claim 1 wherein the soiling shield is positioned relative to the blade airfoil such that the shield does not create more than 10% of a total lift created by the blade airfoil when an angle of attack of the blade airfoil is between 0° and 10°.

10. The wind turbine generator of claim 1
wherein a first line extends from a midpoint of a shield chord and perpendicularly intersects an outer surface of the blade airfoil at a first point, and wherein a tangent line is tangent to the outer surface of the blade airfoil at the first point;
wherein an angle between the shield chord and the tangent line is between ±30 degrees.

11. The wind turbine generator of claim 1 wherein the shield is positioned within 10 cm of the stagnation point.

12. The wind turbine generator of claim 1 wherein a first line extending from a first shield endpoint to a perpendicular intersection with an outer surface of the blade has a first length and a second line extending from a second shield endpoint to a perpendicular intersection with the blade outer surface has a second length, wherein the first and second lengths are each between 2 and 20 cm and within ±5 cm of each other.

13. The wind turbine generator of claim 1 wherein:
a first line extending from a first shield endpoint and intersecting the blade perpendicularly at a first blade point and a second line extending from a second shield endpoint and intersecting the blade perpendicularly at a second blade point;
a third line extending from the first blade point and perpendicularly intersecting a local blade chord at a first chord point and a fourth line extending from the second blade point and perpendicularly intersecting the local blade chord at a second chord point;
wherein a first distance between the leading edge point and the first chord point is between about 0% and 10% of a local chord length; and
wherein a second distance between the leading edge point and the second chord point is between about 0% and 10% of the local chord length.

14. The wind turbine generator of claim 1 wherein a length of the shield along a shield surface and between shield endpoints is between about 1% and 20% of a local chord length.

15. The wind turbine generator of claim 1 wherein a material of the shield comprises a plastic or a fiber material.

16. The wind turbine generator of claim 1 wherein a shield contour is deformable in situ to align with airflow streams flowing over the blade airfoil.

17. The wind turbine generator of claim 1 further comprising struts for attaching the shield to the blade airfoil.

18. The wind turbine generator of claim 1 further comprising a mechanism configured to regulate a gap between the soiling shield and the blade airfoil.

19. The wind turbine generator of claim 1 wherein the soiling shield comprises a first portion extending along and spaced apart from the pressure side of the blade airfoil and a second portion extending along and spaced apart from the suction side of the blade airfoil, the stagnation point between the first and second portions.

20. A method for reducing wind turbine generator blade soiling, comprising:
attaching a soiling shield to a blade airfoil with a portion of the shield extending along and spaced apart from a pressure side surface of the blade airfoil; and
positioning the shield not to impede an air flow stream flowing to a stagnation point on the pressure side surface during operation of the wind turbine generator at or below rated power.
